(19) United States
(12) Patent Application Publication
(10) Pub. No.: US 2018/0207690 A1
(43) Pub. Date: Jul. 26, 2018

(54) Apparatus and Method of Ultrasonic Cleaning

(71) Applicant: Cynthia Tochi Ugorji, (US)

(72) Inventors: Cynthia Tochi Ugorji, Woodbridge, VA (US); Isaac Ballinas, Pittsburgh, PA (US)

(73) Assignee: Cynthia Tochi Ugorji, Woodbridge, VA (US)

(21) Appl. No.: 15/411,625

(22) Filed: Jan. 20, 2017

(51) Int. Cl. B08B 3/12; B08B 3/02; B08B 3/08; A41G 5/00; B65G 15/00; B65G 15/30; F26B 15/18; F26B 21/00

(52) U.S. Cl. CPC B08B 3/123; B08B 3/022; B08B 3/08; F26B 21/004; B65G 15/00; B65G 15/30; F26B 15/18; A41G 5/004

(57) ABSTRACT

A hair extension is conveyed through a fluid held in a tub of a housing, in a conveying direction, while an ultrasonic transducer establishes ultrasonic cavitation at interfaces of the fluid with surfaces of the hair extension. The hair extension is rinsed while conveyed above the fluid to a completion position.

### BACKGROUND

### 1. Field of the Disclosure

This disclosure pertains to cleaning of hair extensions and, more particularly, to ultrasonic cleaning of hair extensions.

### 2. Description of Related Art

Hair extensions and tracks have been long known. Difficulties and problems with washing of the hair extensions, to maintain their appearance, have also been long known. Techniques include hand washing, by immersion in soap and water, manual squeezing and manipulation, followed by water rinsing. However, problems with hand washing can include time spent on the task, as well as damage of the hair extension. For example, hand squeezing and manipulation may be excessive, in force, duration, or both. Also, particularly in hard water areas, repeated rinsing—with accompanying wear on the hair extension—may be needed. There are conventional techniques for machine washing of hair extensions. One such technique included placing the hair extensions in a drawstring netting bag, then placing the netting bag in a conventional clothes washer. However, problems with this technique can include damage and wear of the hair extension, for example due to incorrect or unavailable washer settings. Another problem can be cost from running a washing machine—for example at a laundromat—having only the netting container as its load. Another conventional machine washing technique employs smaller, special purpose detergent-and-water machines, having a small tank and agitator. However, problems with this technique include cost of the machine.

### BRIEF DESCRIPTION OF THE DRAWINGS

The drawing figures graphically illustrate examples of various implementations according to disclosed methods, systems, and aspects thereof. The figures illustrate by way of example only, not by way of limitation. In the figures, like reference numerals refer to the same or similar elements.

FIG. 1 illustrates a cutaway front projection of one implementation of one hair extension ultrasonic cleaning apparatus according to one or more disclosed aspects.

FIG. 2 shows the FIG. 1 illustration, with labeled segments of the conveyor track.

FIG. 3 shows the FIG. 1 illustration, with labeled sections associated with stages of an ultrasonic cleaning process according to various aspects.

FIGS. 4A-4E show stages, and associated operations and positions of a hair extension, relative to the FIG. 3 sections, in an ultrasonic cleaning process according to various aspects.

FIG. 5 illustrates a functional block diagram of an example a computer controller system on which aspects of this disclosure may be implemented

### DETAILED DESCRIPTION

In the following detailed description, numerous specific details are set forth by way of examples in order to provide a ready understanding of aspects and various implementations thereof. However, it should be apparent that various aspects can be practiced without such details, well known components, operations and techniques, within combinations and arrangements according to disclosed aspects are described at a relatively high-level, without detail, in order to avoid unnecessarily obscuring aspects.

The phrases “such as,” “for example,” “including,” and “includes,” as used herein, will be understood to mean, respectively: “such as, but not limited to,” “for example, but not limited to,” “including, but not limited to,” and “includes, but is not limited to.”

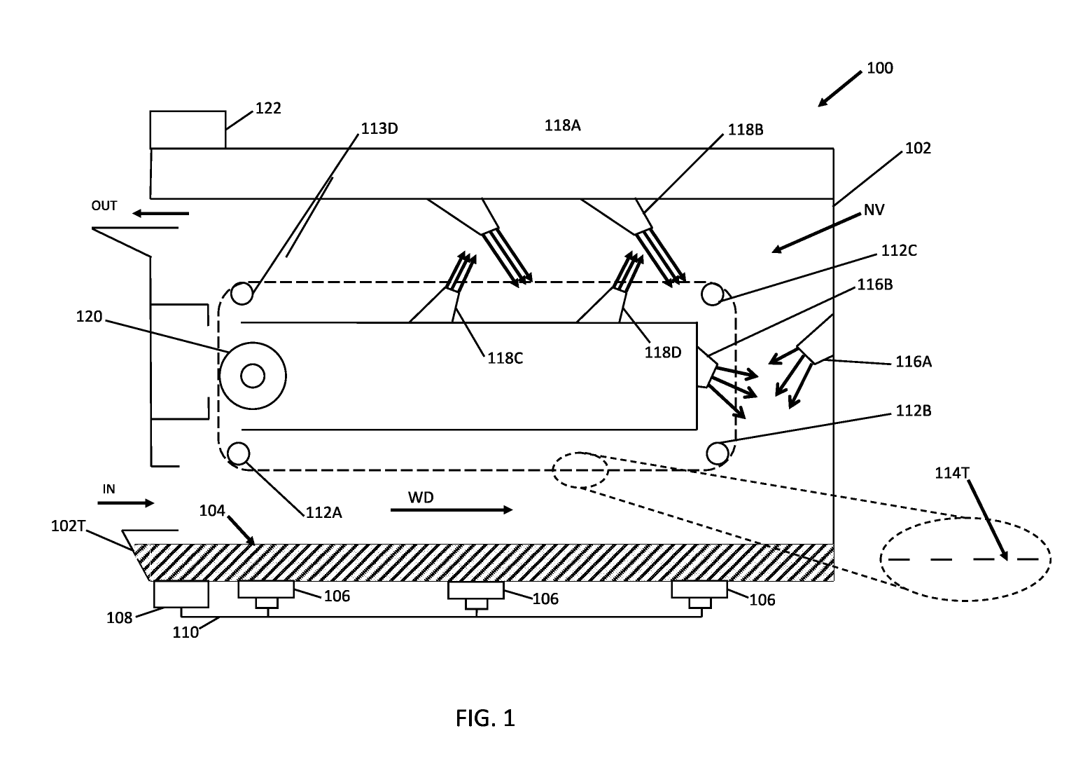

FIG. 1 illustrates a cutaway front projection of one hair extension ultrasonic cleaning apparatus 100, according to various aspects. For brevity, the phrase “ultrasonic cleaning” will be alternatively recited using the arbitrary abbreviation “UTC.” Referring to FIG. 1, the hair extension UTC apparatus 100 can include a housing 102 which can be configured to surround, or partially surround an interior volume, labeled “NV.” A lower region of the housing 102 can be configured as a tub 102T. It will be understood that the term “tub” is not intended as any limitation of structure. For example, implementations of the tub 102T can include, but are not limited to, structures within the plain, ordinary meanings of “reservoir,” “fluid pan,” “fluid tray,” and “basin.” The tub 102T can be configured to be filled with and to hold a UTC fluid bath 104.

Referring to FIG. 1, in an implementation, the hair extension UTC apparatus 100 can include one or more ultrasonic transducers, such as the illustrated configuration of plurality of N ultrasonic transducers 106, “N” being an integer. The N ultrasonic transducers 106 can be arranged and distributed over regions of the lower housing 102L that support the UTC fluid bath 104. In an implementation, an ultrasonic transducer activation signal generator 108 can be included, and a hardwire signal coupling 110 (visible in FIG. 1, but not separately labeled) can be included to carry the generated ultrasonic signal to all N of the ultrasonic transducers 106.

Implementations of the UTC fluid bath 104 can include a water-based emulsifying solution, as this can hold oil-based contaminants in solution. This implementation and other example implementations of UTC fluid bath 104 are described in greater detail later in this disclosure.

Referring to FIG. 1, the hair extension UTC apparatus 100 can include, within the interior volume NV, a conveyor assembly that can include, for example, a first roller 112A, second roller 112B, third roller 112C, and fourth roller 112D (collectively “rollers 112”), configured and arranged to support a conveyor track 114. The axis (visible in FIG. 1 but not separately labeled) of the third roller 112C can be spaced above the axis of the second roller by a height. The height establishes, at least in part, a distance over which rinse water nozzles, such as the example rinse water nozzles 116A and 116B, can be configured and arranged to apply rinse water to a hair extension, as will be described in greater detail later. Likewise, the axis (visible in FIG. 1 but not separately labeled) of the fourth roller 112C can be spaced above the axis of the first roller 112A by the same or another height. For purposes of description, the height of the third roller 112C over the second roller 112B can be termed a “first height,” and the height of the fourth roller 112D over the first roller 112A can be termed a “second height.”

The conveyor track 114 can have a width (not fully visible in FIG. 1) in a direction normal to (i.e., into and out from) the FIG. 1 image plane. In an aspect, the conveyor track 114 can be configured as a perforated or net-like flat belt, having through passages, of which representative examples are labeled 114T. In an aspect, the through passages can allow rinse water, such as output from the FIG. 1 example configuration of rinse water nozzles 116A and 116B or air jet flow, such as output from the FIG. 1 example configuration air nozzles, 118A, 118B, 118C, and 118D, or both, to reach hair extensions while being conveyed by the conveyor track 114, as will be described in greater later in this disclosure.

Referring to FIG. 1, in an implementation, a track actuator such as the example track drive motor 120 can engage, for example, the underside of the conveyor track 114 and move the conveyor track 114 in the direction labeled “WD.” The direction labeled WD can be referred to as the “operating direction.” One control of the track drive motor 120 can be a single-speed ON-OFF control, for example, a manually actuated ON-OFF switch (not visible in FIG. 1) an outer surface of the housing 102. Another control of the track drive motor 120 can be manually actuated multi-speed control switch (not visible in FIG. 1), on an outer surface of the housing 102. In an implementation, control of the track drive motor 120 can be provided, for example, by the controller 122, which is described in greater detail later in this disclosure. Regarding electric power for the track drive motor 120, and for other features of the hair extension UTC apparatus 100, a power supply (not visible in FIG. 1) can receive, for example a mains electrical supply, such as 110V alternating current (AC). The power supply can be configured to then convert the mains electrical to an appropriate form for the track drive motor 120 and other features. In an aspect, the track drive motor 120 can be configured to directly receive mains voltage.

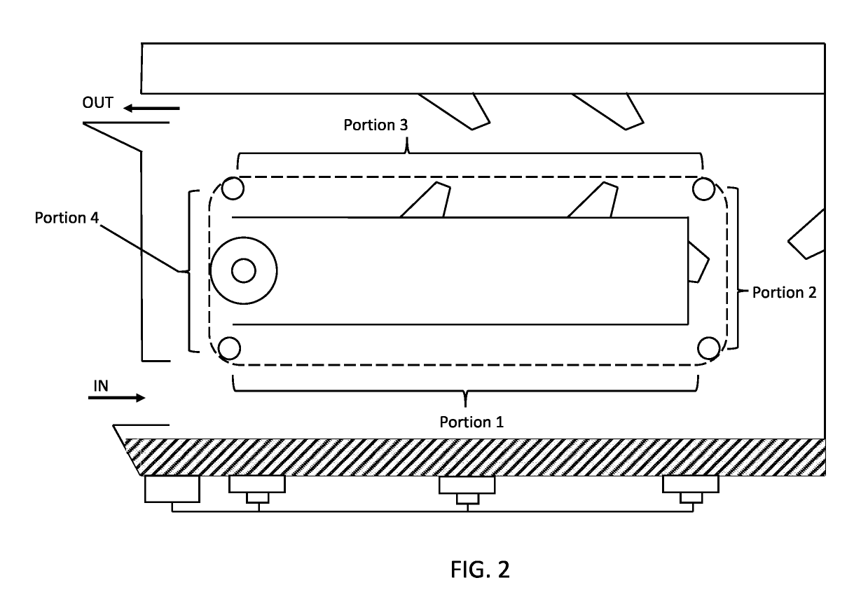

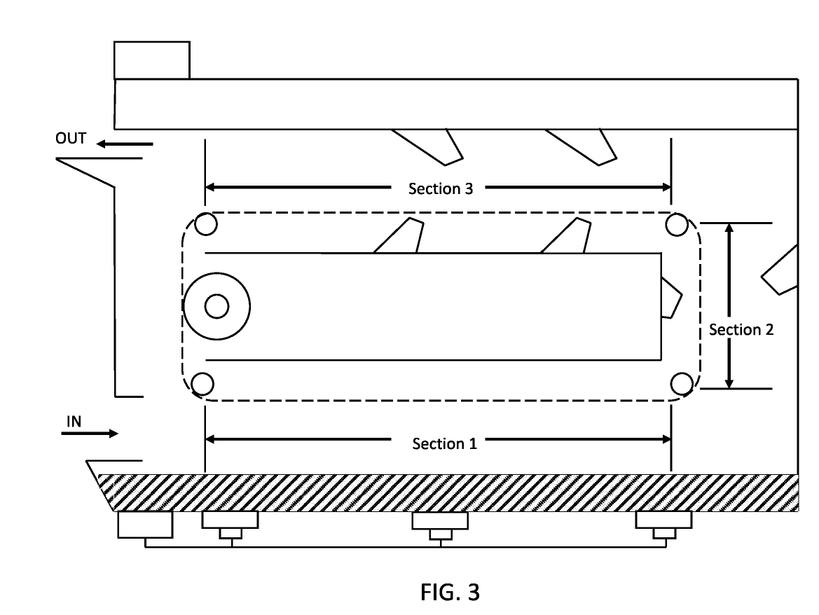

FIG. 2 shows the FIG. 1 illustration, with portions of the conveyor track 114 labeled for reference. FIG. 3 shows the FIG. 1 illustration, with a labeling applied to different regions through which the conveyor track 114 moves, in association with different stages of ultrasonic cleaning processes according to various aspects.

Referring to FIG. 1, in an implementation, the housing 102 of the hair extension UTC apparatus 100 can include an inlet opening, labeled “IN” and an outlet opening, labeled “OUT.” The inlet opening IN can be configured and dimensioned to allow, for example, a human hand to introduce a hair extension (not visible in FIG. 1) a sufficient distance into the interior volume NV to contact the conveyor track 114. Referring to FIGS. 1 and 2, the contact can be proximal to the inlet opening IN, at a portion or region of the conveyor track 114 that extends between the first roller 112A and the second roller 112, which is labeled as the “first portion.” The track drive motor 120 can then be activated, for example by the controller 122, to move the conveyor track 114 in the operating direction WD. This moves the hair extension through the UTC fluid bath 104 toward the second roller 112B. Referring to FIGS. 1 and 3, this section within the interior volume NV of the hair extension UTC apparatus 100 is labeled as the “First Section.” In an implementation, concurrent with the first portion of the conveyor track 114 conveying the hair extension through the UTC fluid bath 104 in the first section, the ultrasonic transducer activation signal generator 108 can provide an ultrasonic transducer activation signal to the ultrasonic transducers 106. The ultrasonic transducers 106, in response, can apply ultrasonic energy to the UTC fluid bath 104, at an amplitude and frequency that establishes ultrasonic cavitation bubbles at interfaces between the liquid in the UTC fluid bath 104 and surfaces of strands of hair (natural or synthetic) of the hair extension. The specific frequency of the ultrasonic transducer activation signal, its amplitude or range of amplitudes, and the amplitude of the ultrasonic energy applied to the UTC fluid bath 104 can be determined or selected based, at least in part, on factors including the chemical composition of the UTC fluid bath 104, the particular shape and material composition of the tub 102T, and the particular characteristics of the ultrasonic transducers 106. Identification of such factors, and selection of the frequency and amplitude of the ultrasonic transducer activation signal can be performed by persons of ordinary skill, upon reading this disclosure and, therefore, further detailed description is omitted.

In an implementation, either via the controller 122 or an ON-OFF switch, the track drive motor 120 can be operated at a constant speed throughout conveying of the hair extension from the input opening IN to the outlet opening OUT. A person of ordinary skill, facing a particular given application and having possession of this disclosure can readily determine an acceptable rate, or range of acceptable rates, without undue experimentation. Further detailed description is therefore omitted. In an implementation, the controller 122 can be configured to switch the speed of the track drive motor 120 and therefore the rate, i.e., distance per unit time, to values specific to the first portion of the conveyor track 114 conveying the hair extension through the first section. According to this implementation the controller 122 can be configured to switch the track drive motor to different speeds rates when the hair extension is being conveyed through other sections of the hair extension UTC apparatus 100.

Referring to FIGS. 1-3, after a hair extension is conveyed through the UTC fluid bath 104 in the first section, it reaches the second roller 112B. The portion of the conveyor track 114 labeled in FIG. 2 as the “second portion,” which moves upward in response to movement of the conveyor track 114 in the WD direction, can then convey the hair extension upward, from the tub 102T and the UTC fluid bath 104, toward the third roller 102C. The section of the hair extension UTC apparatus 100 through which this conveys the hair extension is labeled in FIG. 3 as the “Second Section.” In an implementation, in the Second Section one or more rinse water nozzles can be arranged and configured to spray rinse water toward the outer surface of the second portion of the conveyor track 114. Referring to FIG. 1, one example can be the above-described rinse water nozzle 116A. In an aspect, either as an alternative or supplement to rinse water nozzle 116A, the Second Section can include one or more rinse water nozzles arranged and configured to spray rinse water from the underside of the conveyor track, through the passages 114T. One example can be the above-described rinse water nozzle 116B. In an implementation, the rinse water nozzles 116 can be fed by a rinse water pump (not visible in the figures). In an aspect, the rinse water pumps can operate continuously, regardless of whether a hair extension is in the Second Section. In another aspect, the rinse water pump or a valve mechanism (not visible in the figures) associated with the rinse water pump, can be controllable, for example, by the controller 122. This aspect can include configuring the controller 122 to cause rinse water spray from the Second Section rinse water nozzles 116 only when a hair extension is being conveyed through the Second Section.

Referring to FIGS. 1-3, after a hair extension is conveyed upward through the Second Section, and is thereby rinsed by the rinse water nozzles 116, it reaches the third roller 112C. The portion of the conveyor track 114 labeled in FIG. 2 as the “third portion” moves, in response to movement of the conveyor track 114 in the WD direction, in a direction opposite the direction of the first portion, can then convey the hair extension toward the fourth roller 112D, which is toward the outlet opening OUT. The section of the hair extension UTC apparatus 100 through which this conveys the hair extension is labeled in FIG. 3 as the “Third Section.” In an implementation, in the Third Section one or more air nozzles can be arranged and configured to emit an air jet toward the upper surface of the third portion of the conveyor track 114. Referring to FIG. 1, an example can be the above-described air nozzle 118A, or 118B, or both. In an aspect, either as an alternative or supplement to air nozzles 118A or 118B, the Third Section can include one or more air nozzles arranged and configured to emit an air jet from the underside of the conveyor track, through the passages 114T. An example can be the above-described air nozzle 118C, or 118D, or both. The air nozzles 118A-118D are exemplary only. In one implementation, the hair extension ultrasonic cleaning apparatus may not include the air nozzles 118A-118D.

In an implementation, the air nozzles 118 can be fed by an air pump (not visible in the figures). In an aspect, the air pump can operate continuously, regardless of whether a hair extension is in the Third Section. In another aspect, the air pump can be controllable, for example, by the controller 122. This aspect can include configuring the controller 122 to activate the air pump only when a hair extension is being conveyed through the Third Section.

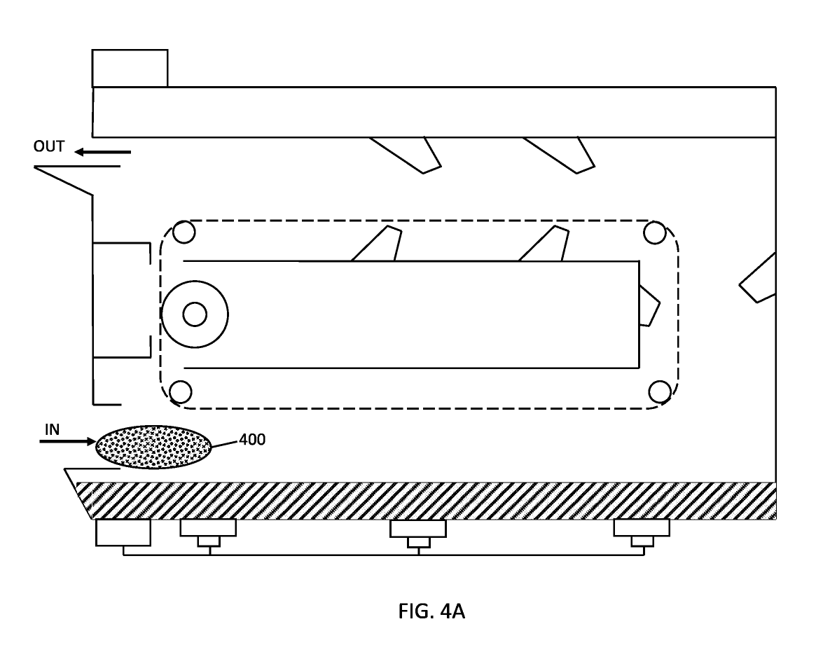

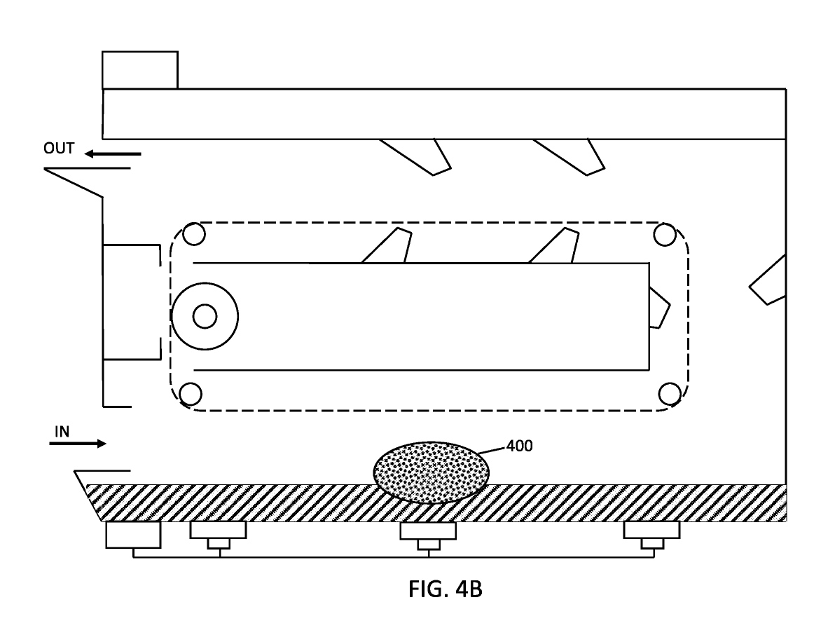

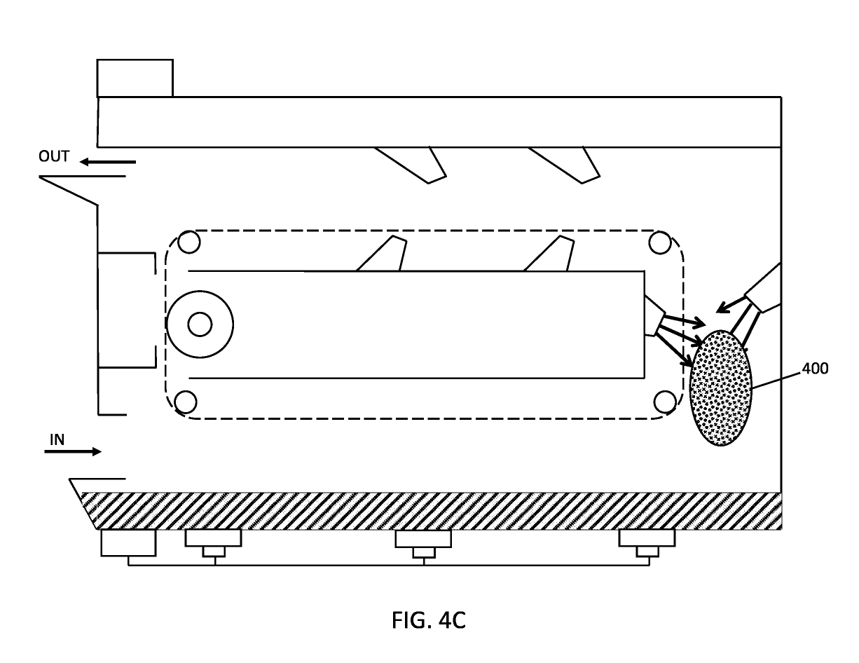

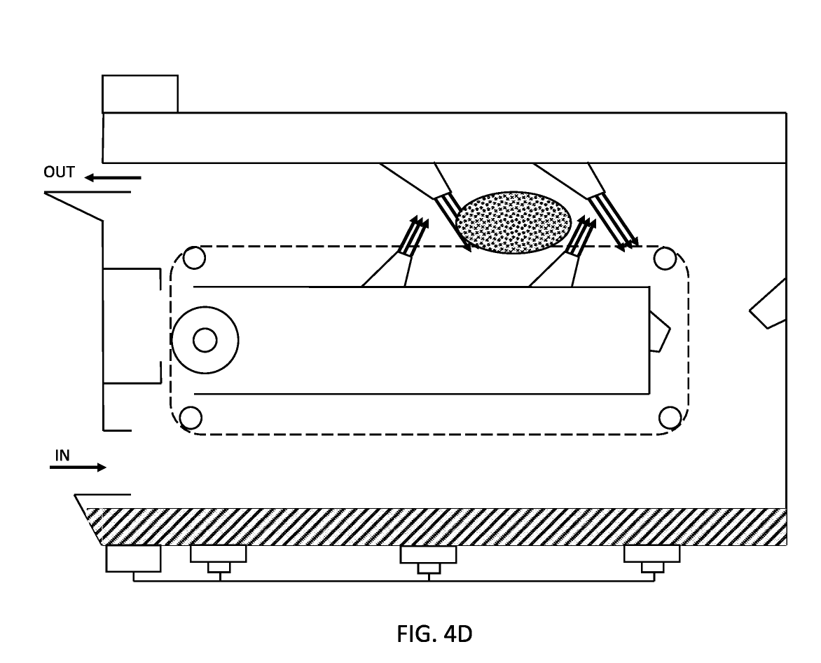

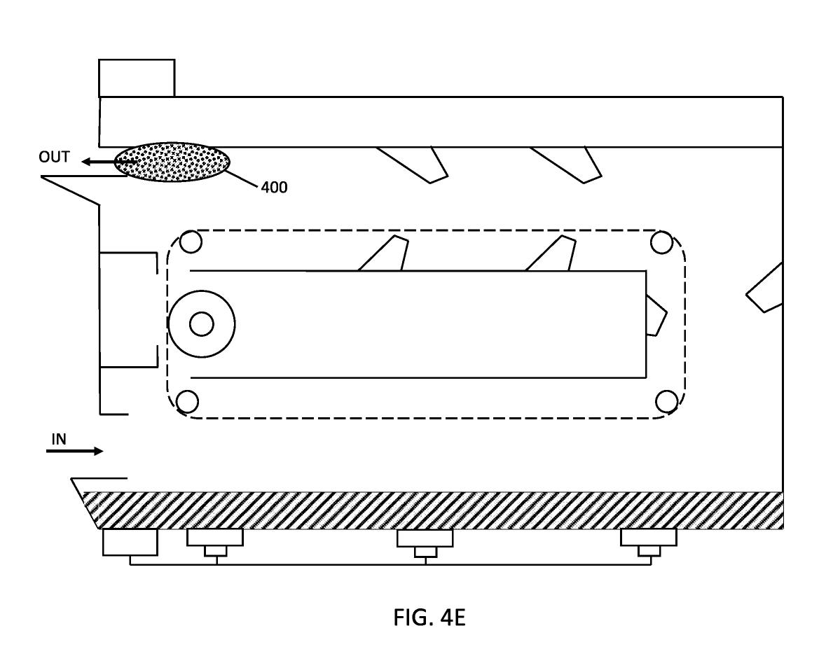

FIGS. 4A-4E show stages, and associated operations and positions of a hair extension, relative to the FIG. 3 sections, in an ultrasonic cleaning process according to various aspects.

Referring to FIG. 4A, in one process operations can begin with inserting a subject hair extension 400, through the inlet opening IN to a position (e.g., near the first roller 112A) contacting the conveyor track 114. Referring to FIG. 4B, the hair extension 400 is then conveyed through the First Section and the UTC fluid bath 104. Concurrently, the ultrasonic transducer activation signal generator 108 can provide an ultrasonic transducer activation signal to the ultrasonic transducers 106. The ultrasonic transducers 106, in response, can apply ultrasonic energy to the UTC fluid bath 104 that establishes cavitation at interfaces with the hair extension 400, as described above. Referring to FIG. 4C, the hair extension 400 is then conveyed upward through the Second Section, where rinse water nozzle 116A, or rinse water nozzle 116B, or both, and/or other rinse water emitters spray rinse water onto the hair extension. Referring to FIG. 4D, the hair extension 400 is then conveyed through the Third Section, where air nozzles, e.g., one or more of the air nozzles 118, emit or inject one or more air jets onto the hair extension. Referring to FIG. 4E, the hair extension 400, after being ultrasonic washed in the First Section, rinsed in the Second Section, and dried in the Third Section arrives at the outlet opening OUT, where it can be removed.

As described above, one implementation of the UTC fluid bath 104 can include a water-based emulsifying solution. One feature of this implementation is that it can hold oil-based contaminants in solution. An alternative implementation of the UTC fluid bath 104 can include a water-based demulsifying solution. In such an implementation, it may be preferable to include a surface skimmer (not visible in FIG. 1), configured to be readily removable and cleanable by a consumer user.

Fluids for the above example implementations and other implementations of the UTC fluid bath 104 are available from various vendors such as, for example, Crest Ultrasonics, 10 Grumman Avenue, Trenton, N.J. 08628; and Bluewave Ultrasonics, 960 S. Rolf Street, Davenport, Iowa 52801. Selection of the implementation (i.e., which UTC solution(s) to use) of the UTC fluid bath 104 can be in part a design choice, and in part can be based on considerations that a person of ordinary skill would readily understand upon reading this disclosure. Examples of such considerations, as will be understood by such persons upon reading his disclosure include, but are not limited to, the type(s) of hair extensions for cleaning, e.g., whether natural or synthetic; user preference as to odor; and what material(s) form portions of the housing 102 that support the UTC fluid bath 102 (e.g., plastic or metal and, if so, which specific plastic or metal). Persons of ordinary skill, upon reading this disclosure, can therefore select a formulation or range of formulations of the UTC fluid bath 104 for practices according to disclosed aspects without undue experimentation. Further detailed description of such selection can therefore be omitted.

Referring to FIG. 1, in an aspect the housing 102 can be implemented as a multi-piece structure, for example, the housing 102 can be an assembly of an upper housing (not shown separately in the figures) and a lower housing (not shown separately in the figures).

In an implementation, whether the housing 102 is implemented as a single piece structure or a multi-piece structure, one or more drain plugs (not visible in FIG. 1) can be arranged within the housing 102 for emptying the UTC fluid bath 104 from the tub 102T. In addition, the housing 102 can be configured with one or more fill openings (not visible in FIG. 1).

Regarding indicating or monitoring the level of the UTC fluid bath 104, one implementation can provide for visual inspection, for example, by arranging a clear plastic window (not visible in FIG. 1) in a region of the tub 102T. Another implementation can provide a fluid level sensor (not visible in FIG. 1).

Referring to FIG. 1, it will be understood that the population of rollers 112 being four is only one example, and not a limitation. For example, another roller 112 can be arranged at a location between the first roller 112A and the second roller 112B. It will be understood that one or more of the rollers 112 can be implemented by, for example, an idler wheel, or sprocket (neither of which is visible in FIG. 1).

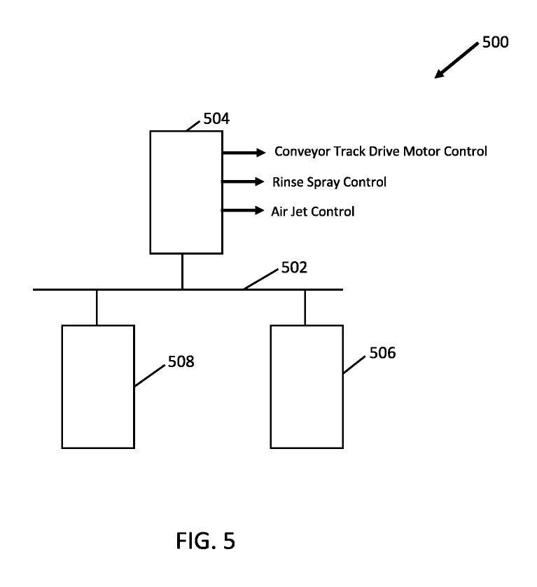

FIG. 5 is a block diagram that illustrates a computer controller 500 upon which aspects of this disclosure, for example the controller 122, may be implemented. Computer controller 500 can include a bus 502, a processor 504 and a main memory 506 coupled with the bus 502. The main memory 506 can be implemented as a random access memory (RAM) or other read-write storage device, configured to store information and instructions to be executed by processor 504. The computer controller 500 can further include, or can interface to, a display 508, for example, a liquid crystal display (LCD). The display 508 can be controller, for example, to indicate to the user that the hair extension UTC apparatus 100 is powered on, or what stage a cleaning process is currently in, or whether the hair extension UTC apparatus 100 requires service (e.g., replacement of the UTC fluid bath 104). The computer controller 500 can further include a read only memory (ROM) or other non-volatile storage device (not visible in FIG. 5), for example, coupled to bus 502 for storing static information. In an aspect, the processor 504 can be configured to execute one or more sequences of one or more instructions contained in main memory 506. Execution of the sequences of instructions contained in main memory 506 causes processor 504 to perform the process steps described herein. In some examples, hard-wired circuitry may be used in place of or in combination with software instructions to implement the various aspects of this disclosure. Thus, implementations are not limited to any specific combination of hardware circuitry and software.

The term “machine-readable medium” as used herein refers to any medium that participates in providing data that causes a machine to operation in a specific fashion. Implementations of machine-readable medium include but are not limited to, non-volatile media, volatile media, and transmission media. Non-volatile media includes, for example, optical or magnetic disks, memory sticks, and magnetoresistive memory. Transmission media includes coaxial cables, copper wire and fiber optics, including structure forming comprise the bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

While the foregoing has described what are considered to be the best mode and/or other examples, it is understood that various modifications may be made therein and that the subject matter disclosed herein may be implemented in various forms and examples, and may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the general nature of the technical disclosure. It is not intended to limit the scope or meaning of the claims. In addition, in the foregoing Detailed Description, various features are grouped together in various examples for convenience. The grouping does not imply, and is not to be understood as stating that any claim requires more features than the claim expressly recites. The following claims are hereby incorporated into the Detailed Description, with each claim standing on its own as a separately claimed subject matter.

What is claimed is:

1. A method for cleaning a hair extension, comprising:
conveying the hair extension through a fluid in a conveying direction;
establishing ultrasonic cavitation at interfaces of the fluid with surfaces of hair strands of the hair extension, during at least a portion of the conveying;
conveying the hair extension to a completion position that is above the fluid; and
rinsing the hair piece during the conveying to the completion position.

2. The method of claim 1, wherein conveying the hair extension through the fluid is in a forward conveying direction, and wherein a portion of the conveying the hair extension to the completion position includes conveying the hair extension in a reverse conveying direction, opposite the forward conveying direction.

3. The method of claim 2, wherein conveying the hair extension through the fluid includes conveying the hair extension through a fluid bath within a housing.

4. The method of claim 3, further comprising moving a conveyor track along a continuous loop, the continuous loop having a first portion that moves through or proximal to the fluid in the forward conveying direction, a second portion that moves away from the fluid, and a third portion that moves above the fluid, in the reverse conveying direction.

5. The method of claim 4, wherein rinsing the hair extension includes spraying a rinsing liquid onto the hair extension from a position adjacent the second portion, wherein at least a portion of the rinsing liquid passes over hair strands and through interstices between hair strands of the hair extension, and through passages in the conveyor track.

6. The method of claim 4, further comprising ejecting an air jet, from an air nozzle above the third portion in a direction toward an upper surface of the third portion.

7. The method of claim 4, wherein the method further comprises inserting the hair extension through an inlet opening of a housing, to contact the hair extension against a surface of the first portion of the conveyor track.

8. The method of claim 7, wherein rinsing the hair extension further includes spraying a rinsing liquid through passages in the second portion of the conveyor track, to then over hair strands and through interstices between hair strands.

9. The method of claim 8, further comprising ejecting another air jet, from another air nozzle under the third portion of the conveyor track, in a direction toward an underside of the third portion, to pass through passages in the third portion.

10. An ultrasonic washing apparatus, comprising:
a housing enclosing a volume, having an end opening configured to receive a hair extension into the volume, and configured to hold a liquid bath, having a top surface;
a conveyor, arranged within the volume, having an engagement surface configured to engage a hair extension, and to move the hair extension through the liquid batch, to a completion position that is above the liquid bath;
an ultrasonic transducer, configured to apply ultrasonic energy into the volume, during at least a portion of moving the hair extension through the liquid bath; and
a rinsing nozzle, configured to eject rinsing liquid toward the hair extension during at least a portion of the conveyor moving the hair extension to the completion position.

11. The ultrasonic washing apparatus of claim 10, wherein conveyor is configured to move the hair extension in a first direction through the liquid bath and, during at least a portion of moving the hair extension to the completion position, to mode the hair extension in a second direction opposite the first direction.

12. The ultrasonic washing apparatus of claim 11, wherein the conveyor comprises:
a roller support, arranged within the volume;
a plurality of rollers, each roller having being supported by the roller support to be rotatable;
a conveyor track supported by the plurality of rollers, the conveyor track configured as a continuous loop, having a first portion, a second portion, and a third portion
a track actuator, configured to move the conveyor track in a direction, the movement causing movement of the first portion in a first direction, movement of the second portion in a second of the first segment in the first direction, and movement of the second segment in the second direction.

13. The ultrasonic washing apparatus of claim 12, wherein the plurality of rollers includes a first roller, a second roller, a third roller, and a fourth roller,
wherein the first portion extends between the first roller and the second roller, the second portion extends between the second roller and the third roller, and the third portion extends between the third roller and the fourth roller.

14. The ultrasonic washing apparatus of claim 13, wherein the axis of the third roller is spaced above the axis of the third roller by a height.

15. The ultrasonic washing apparatus of claim 14, further comprising:
a rinsing nozzle, configured to receive a flow of a rinsing liquid flow and to spray the received rinsing liquid as a rinsing spray, toward the second portion.

16. The ultrasonic washing apparatus of claim 14, wherein the track actuator includes a motor, the motor being mechanically coupled to the conveyor track, wherein the apparatus further comprises:
a controller, coupled to the motor, wherein the controller is configured to control the motor to move the conveyor track at a given rate when the first portion of the conveyor track is moving the hair extension through the liquid bath, and to move the conveyor track at another rate, different from the given rate, when the second portion of the conveyor track is moving the hair extension through the rinsing spray.

17. The ultrasonic washing apparatus of claim 16, wherein the conveyor track includes through passages, wherein the rinsing nozzle is configured to spray at least a portion of the rinsing spray through the at least one through passage when the at least one through passage is in the second portion.

18. The ultrasonic washing apparatus of claim 14, further comprising:
an air nozzle, configured to receive a flow air and to emit the air as an air jet, toward the third portion.

19. The ultrasonic washing apparatus of claim 18, wherein the controller is further configured to control the motor to move the conveyor track at a given rate when the first portion of the conveyor track is moving the hair extension through the liquid bath, and to move the conveyor track at another rate, different from the given rate, when the third portion of the conveyor track is moving the hair extension through the air jet.
